(19) United States
(12) Patent Application Publication
(10) Pub. No.: US 2009/0171497 A1
(43) Pub. Date: Jul. 2, 2009

(54) METHOD AND SYSTEM FOR CHANGING MOLD HOLDER PRESSES ON CARRIAGES MOVING ALONG A PROCESSING LINE

(75) Inventors: Massimilano SACCHI, MILAN (IT); Maurizio RONCHI, MILAN (IT)

Correspondence Address: YOUNG & THOMPSON, 209 Madison Street, Suite 500, ALEXANDRIA, VA, 22314, US

(73) Assignee: TECNOS S.P.A., MILAN (IT)

(21) Appl. No.: 12/345,022

(22) Filed: Dec. 29, 2008

(30) Foreign Application Priority Data
Dec. 27, 2007 (IT) MI2007A 002434

(51) Int. Cl. B29C 39/06; G06F 7/00

(52) U.S. Cl. 700/197; 700/229

(57) ABSTRACT

A plurality of carriages, each provided with a relevant mold holder press, are movable along a processing line comprising a press removal and/or replacement area. Whenever a carriage arrives in correspondence with the press removal and/or replacement area, a shuttle provided with gripping forks, comes alongside and is controlled to move in synchronism with the carriage to take out a mold holder press by lifting and removing it while the carriage is in movement; the shuttle subsequently provides to transfer, by the same system method, a new mold holder press onto the same carriage, or onto a subsequent empty carriage, in movement along the press removal and/or replacement area.

### BACKGROUND OF THE INVENTION

The present invention concerns certain improvements to plants for manufacturing articles of molded plastic material, in particular polyurethane material which is poured or injected into a cavity of a mold enclosed in a clamping press supported by a carriage movable along a molding path, for example an annular-shaped path, of a processing or manufacturing line.

In particular, the invention concerns both a method and a system or plant for automatically changing, within an extremely limited length space of time, mold holder presses with a clamped mold while the supporting carriages move along the processing line.

### STATE OF THE ART

In the manufacture of molded articles of plastic material, in particular polyurethane resins, usually use is made of a plurality of molds carried by carriages movable along a processing line, where the molds are cyclically made to advance through a plurality of work stations. The molds are enclosed in clamping presses supported by carriages, which in turn can be opened with the mold to allow the feeding, for example of a polyurethane mixture, as well as the removal of a molded article, or cleaning and/or preparatory operations in correspondence with some work stations, or operative areas.

During the manufacturing cycle the need may arise to replace one or more molds of the same, or different type, or to carry out somewhat complicated repair and/or maintenance operations on a mold, or on a press, which require long periods of time with a consequent prolonged interruption of the manufacturing cycle.

In order to partly obviate these drawbacks, various solutions have been studied which, in the case of need, take steps to switch the carriage with the press and the relevant mold onto a shunted path, where the various repair, maintenance, press and/or mold changing operations can be carried out in a specially equipped working area, outside of and in a position spaced apart from the processing line; this prevent from interrupting the manufacturing cycle, while maintaining working conditions of the utmost safety for the operators. Examples can be found in U.S. Pat. No. 4,737,091 and U.S. Pat. No. 5,370,516.

In particular, U.S. Pat. No. 4,737,091 shows a plant for molding articles of polyurethane material, in which a plurality of supporting carriages for mold holder presses are movable along a closed path of a processing line, along which the various work stations are provided. Whenever a mold has to be replaced, or whenever maintenance operations have to be carried out on the mold and on the press, the carriage with the mold holder press is switched onto a subsidiary line, and stopped in a special maintenance area; in this way the working cycle of the processing line is not interrupted.

U.S. Pat. No. 5,370,516 provides a solution in certain ways similar to the previous one, in that, whenever it is necessary to carry out a maintenance operation and/or replacement of a press and/or of a mold, the carriage supporting the mold holder press is once again switched onto a separate line in correspondence with a carriage transfer station.

Although in both these cases the transfer of a carriage with the mold holder press in a maintenance area does not interfere with the working cycle, these solutions prove to be somewhat complex from the structural standpoint and of that of the management of the entire plant; the productivity of the plant is consequently reduced throughout the period in which the carriages with the relevant mold holder presses, remain in the maintenance area.

### OBJECTS OF THE INVENTION

The main object of the present invention is to provide a method and a system whereby it is possible carry out a replacement of the mold holder presses, that is to say, to replace a mold holder press with another one on which maintenance operations and/or mold replacement have previously been carried out, in extremely limited periods of time, without removing the carriages from the processing line; in this way the manufacturing cycle of the entire plant is not negatively affected, and at the same time allows a greater operative flexibility.

A further object of the invention is to provide a method and a system or plant whereby the replacement of the mold holder presses and their transfer to a maintenance area, can be performed out in a totally automatic and programmed way, in correspondence with “dead” sections or specific areas of the processing line; consequently, the overall dimensions of the entire plant can be considerably reduced, as compared to a conventional plant, with consequent advantages in terms of space, costs and productivity.

### BRIEF DESCRIPTION OF THE INVENTION

The idea on which this invention is based consists in carrying out the replacement of a mold holder press, with the relevant mold, from a carriage performing the removal and transfer by a shuttle provided with gripping forks, while the shuttle moves aligned with and in synchronism with the carriage along a specifically dedicated press removal section of a processing line; signal generators provide a control unit with suitable reference signals which allow a control of the position and speed of the shuttle, compared to the carriage, and the operations for gripping and transferring the mold holder presses, while maintaining the entire system of carriages in movement.

In particular, according to the invention, a method has been provided for automatically changing mold holder presses in a processing plant for the continuous manufacture of molded articles of plastic material, according to which each mold is enclosed in a clamping press removably supported by a respective carriage movable along a path of a processing line, comprising the steps of:

providing each press and/or carriage with an identification code;

providing a shuttle with press gripping members for gripping and transferring the presses, said shuttle being movable along a subsidiary path which develops parallel to the working path of the carriages along the processing line, in correspondence with a press and mold removal and/or replacement area;

detecting the approaching of a carriage in the press removal and/or replacement area;

identifying an approaching carriage with a press to be removed, and starting the shuttle to bring it alongside the detected carriage in movement;

generating first and second reference signals indicative of the position and/or speed of the detected carriage, and respectively of the shuttle in movement;

bringing the shuttle alongside the detected carriage;

synchronizing the speed of the shuttle with the speed of the detected carriage by said reference signals; and

removing the mold holder press from the carriage in movement, by lifting and transferring the press onto the shuttle as they move in synchronism along the removal area.

According to another aspect of the invention, a system or plant has been provided for automatically changing mold holder presses, in which each mold holder press is removably supported by a respective clamping carriage movable along a working path of a processing line, and in which a press removal and/or maintenance area has been provided alongside said working path, comprising:

means for detecting and identifying each press and/or carriage approaching said removal and maintenance area;

a presses transferring shuttle movable along a subsidiary path which extends parallel to the working path, in correspondence with said press removal area, the shuttle being provided with press gripping means conformed to lift and move each press between a carriage and the shuttle;

a first signal generator in correspondence with said removal area, to generate a first reference signal co-related to the position and speed of an approaching carriage;

means for connecting the first signal generator to the approaching carriage in correspondence with said press removal area;

a second onboard signal generator for the transfer shuttle, for generating a second reference signal co-related to the position and speed of the same shuttle;

a central control unit for the processing line;

an onboard control unit for the shuttle operatively connected to said central unit and to said signal generators;

the onboard control unit of the shuttle comprising program means for controlling and co-relating, by said reference signals, the position and speed of the shuttle to the position and speed of the carriage in movement, respectively for controlling the lifting and the transfer of a press between a carriage and the shuttle side by side arranged in movement along said removal area.

The shuttle for transferring the presses can be provided with a single or double pair of forks, for gripping, lifting and transferring the presses, whose movements are appropriately controlled by the onboard unit of the shuttle; in the event the shuttle being provided with a single pair of gripping forks, the removal and replacement of the presses takes place at separate times during successive passages of the same carriage. Advantageously, in the event of a shuttle provided with two pairs of forks, the step of replacing a new press can take place directly on the same carriage, after the removal of the press to be replaced.

During the gripping and transferring of the presses, the movement of the shuttle must move in perfect synchronism with the carriage; this can be achieved by controlling the position and speed of the shuttle, by its onboard control unit, in relation to control signals emitted by suitable signal generators. Alternatively it is possible to control the position and speed of the shuttle by entraining the same shuttle by the carriage; in this case the shuttle can be provided with a latch or coupling member to connect it to the carriages or, vice versa, by providing each carriage with a coupling member for entraining the shuttle during the press gripping, lifting and transferring steps.

### BRIEF DESCRIPTION OF THE DRAWINGS

These and further characteristics of the method and of the system or plant according to the invention, and several preferential embodiments, will be more clearly evident from the following description, with reference to the examples of the accompanying drawings, in which:

FIG. 1 shows a layout of a plant for the continuous manufacture of molded articles from plastic material, provided with an automatically changing mold holder presses system according to the invention;

FIG. 2 is a top view of a carriage with the mold holder press;

FIG. 3 is a side view of FIG. 2;

FIG. 4 is a top view of a shuttle for transferring the presses, according to a first embodiment suitable for supporting a single press;

FIG. 5 is a side view of the shuttle of FIG. 4;

FIG. 6 is an illustrative diagram of the control system of the shuttle for transferring the presses;

FIG. 7 shows a view along the line 7-7 of FIG. 1, which illustrates the system of connection, to the carriages, of the generator of reference signals correlated to the position and speed of the carriages themselves;

FIG. 8 shows a general diagram of the apparatus for controlling the position and speed of the carriages and the shuttle, in the press removal area;

FIG. 9 is a first flow diagram of the press changing method according to the invention;

FIG. 10 is a second flow diagram illustrating further operative steps of the press changing method;

FIG. 11 is a view similar to that of FIG. 1, during a first step for transferring press;

FIG. 12 shows a view along the line 12-12 of FIG. 11;

FIG. 13 shows a view similar to that of FIG. 1 during a second step for transferring a press;

FIG. 14 shows a view along the line 14-14 of FIG. 13;

FIG. 15 shows a view similar to that of FIG. 14, during the lifting of a press;

FIG. 16 shows a view similar to that of FIG. 15 with a press on the shuttle;

FIG. 17 shows the press transferred to a maintenance area;

FIG. 18 shows an alternative embodiment with the shuttle provided with double forks, for supporting two presses simultaneously;

FIG. 19 shows an alternative for the system for generating the position and speed reference signals of the carriages;

Figs. from 20 to 24 show subsequent steps for transferring the presses, by the shuttle with double forks of FIG. 18;

FIG. 25 is a flow diagram relating to the steps shown in the figures from 20 to 24.

### DETAILED DESCRIPTION OF THE INVENTION

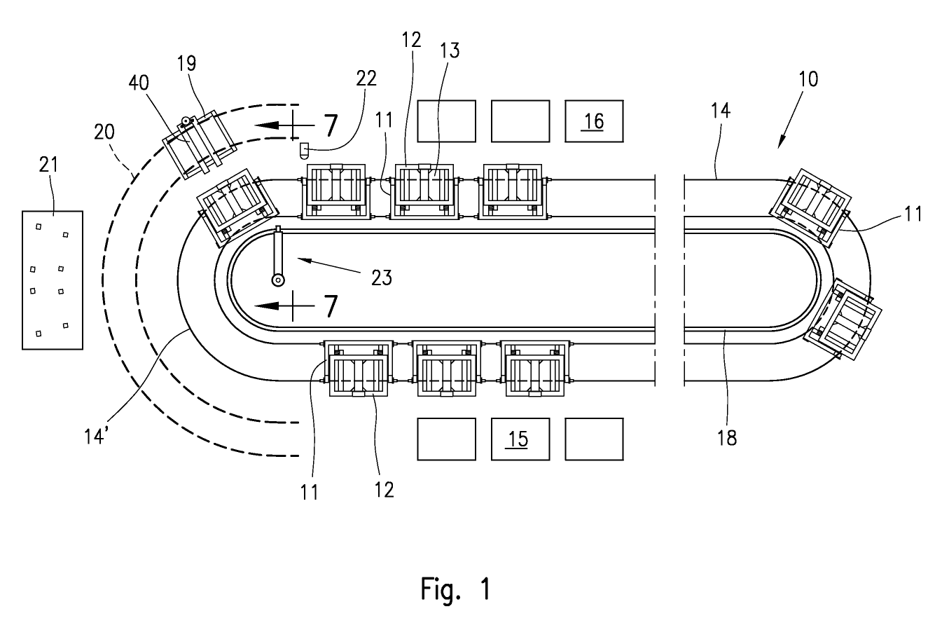

FIG. 1 shows in schematic form a plant for the manufacture of molded articles from plastic material, for example polyurethane material, provided with an automatic system for rapidly changing the mold holder presses, as explained further on.

As shown in FIG. 1, and in the subsequent figures from 2 to 5, the plant comprises a processing line 10 which extends along a closed molding path, for example an annular path, along which a plurality of carriages 11 move, each supporting a press 12 designed to clamp a mold 13.

The carriages 11 move, for example, along a guide rail 14, on one or both sides of which a number of work stations 15 and 16 are disposed, whose number and whose characteristics are depending upon specific manufacturing requirements and the molding technology.

The carriages 11 are mechanically connected to one another, and some of them are provided with a drive motor 17 powered by US line 18 along the entire path 14.

The plant of FIG. 1 is also provided with a system for rapidly changing the presses 11 and/or the molds 12, which automatically operates with the carriages 11 in movement, thus making it unnecessary to stop and switch the carriages away from the working path, negatively affect the manufacturing cycle of the plant, which maintains its operative capacity substantially unchanged.

According to this invention, the system for rapidly changing the presses and/or the molds, with the carriages 11 in movement, comprises a press transfer shuttle 19 for gripping and removing a press 12, which moves in synchronism with a carriage 11 along a subsidiary path 20; as shown in FIG. 1, the subsidiary path 20 extends parallel to the main path 14 for the carriages 11, in correspondence with a working area 21 in which one or more operators can carry out maintenance operations on the presses 12 and/or replacement of the molds 13, in complete safety in a working area far away from moving parts, without interrupting the working of the plant and its productivity.

According to the preferential solution of FIG. 1, the removal and replacement of a presses 12 with the relevant mold 13, takes place along a curved section 14′ of the carriage path, in general consisting of a “dead” section or a section for connecting two rectilinear portions of the processing line.

FIG. 1 shows a plant in which the processing line extends along an annular closed path, consisting of two rectilinear sections joined by two curved sections which develop over an arc of 180°; however, the processing line could develop along a different path, without any detriment to the general characteristics of the system according to this invention.

In the case of FIG. 1, the plant is provided with a shuttle 19 for transferring the presses, capable of picking up removing and transferring a single press 12 at a time; however, use could be made of a double shuttle conformed to pick up a first press from a carriage, and to subsequently transfer a second press onto the same carriage, as explained further on.

The area 21 for the maintenance of the presses 11 and/or replacement of the molds 12 is positioned to a side of the path 20 for the shuttle 19 so that the latter, after having picked up a press 12 from a carriage 11 in movement, can subsequently transfer it into the maintenance area 21; however, without detriment to the main characteristics of the system for automatically changing presses according to this invention, the maintenance area 21 could be differently positioned, by providing a different system for transferring the presses, from the shuttle 19 to the maintenance area 21.

In FIG. 1, the reference number 22 has been used to indicate a sensor or detector device to detect the arrival of a carriage and to identify each carriage and/or the relevant press by reading a special identification code. The management of the entire plant and the replacement steps of the presses, in this way can be carried out automatically by a suitable control unit programmable by an operator.

Lastly, in FIG. 1, reference number 23 has been used to indicate a device for detecting the position and the speed of the carriages 11, which can be selectively coupled to each carriage identified by the control unit, in the curved section 14′ of the path along which the programmed replacement of the presses 11 with relevant molds 12 must take place.

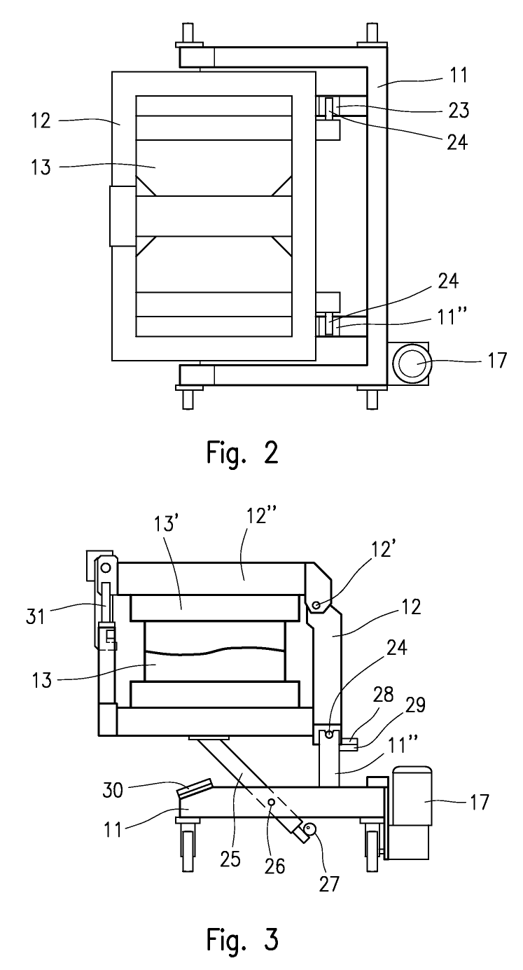

FIGS. 2 and 3 schematically show a possible conformation of a carriage 11 and of the mold holder press 12.

In the example taken into consideration, the carriage 11 has a substantially C-shaped frame open on the front side, that is to say, facing towards the shuttle 19; the carriage 11 is provided with two uprights 11″ defining the seat for a pin 24 secured to a bracket at the rear side of the press 12; an overturnable collapsible arm 25 hinged at 26 to the frame of the carriage 11, supports the press 12 along the path 14; the support arm 25 generally is maintained in the raised position of FIG. 3, and can be controlled to rotate in a disengagement condition of the press 12 in any appropriate way; this can be achieved for example by a linear actuator (not shown) or by a cam system, substantially consisting of an appropriately-shaped bar 27, against which the rear end of the support arm 25 slides along the path of the carriages.

As mentioned previously, several of the carriages 11 are provided with a driving motor 17 operatively connected to a driving wheel. Since the individual carriages 11 and the relevant presses 12 may need to be fed both by electric and by pneumatic power during their movement, or at pre-established points, each carriage 11 and each press 12 are provided with plates 28 and 29 having special connectors, not shown, which allow the connection to electric and/or pneumatic power sources with which the carriages can be provided, and their connection and disconnection by a simple vertical movement of raising and lowering the presses 12.

The press 12, in addition to being vertically removably supported by a carriage 11, also has the possibility to rotate around the pins 24 and to be slanted forward against a stop plate 30 disposed at the front side of the carriage 12. In this condition, the covers 12″ and 13′ of the press 12 and of the 13 can be opened by disengaging the looking device 31 by a cam system or in any other way, thereby enabling the upper portion of the press 12, hinged in 12′ to the lower portion, to be raised and/or overturned backwards to open and gain access to the mold, for example for pouring a polyurethane mixture, for the removal of a molded article, or for the introduction of inserts and/or for cleaning and in-line maintenance operations of the mold 13.

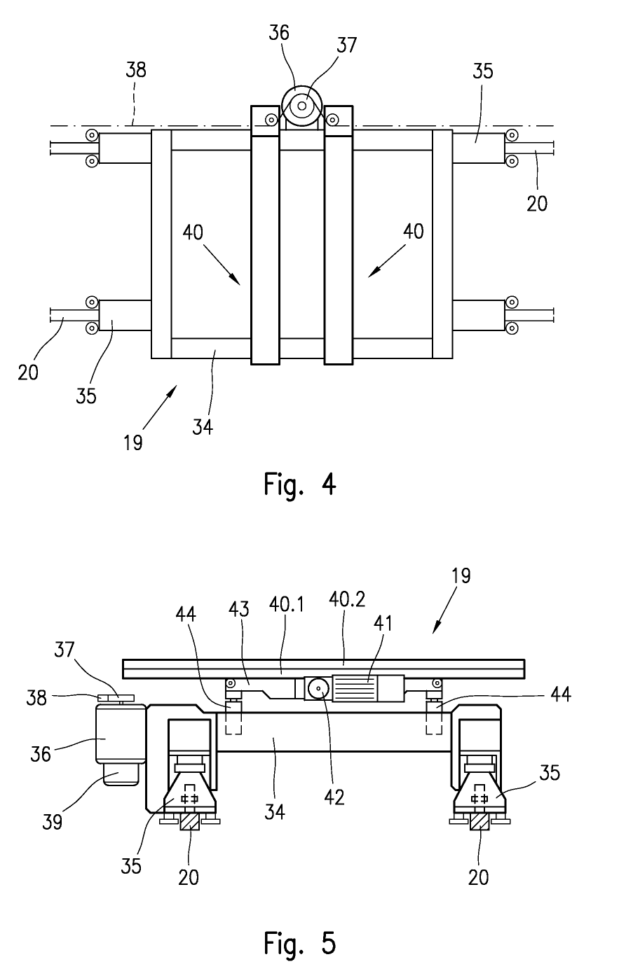

FIGS. 4 and 5 show two different views of the shuttle 19 for transferring the presses 12, conformed in such a way as to support and transfer a single press 12 at a time.

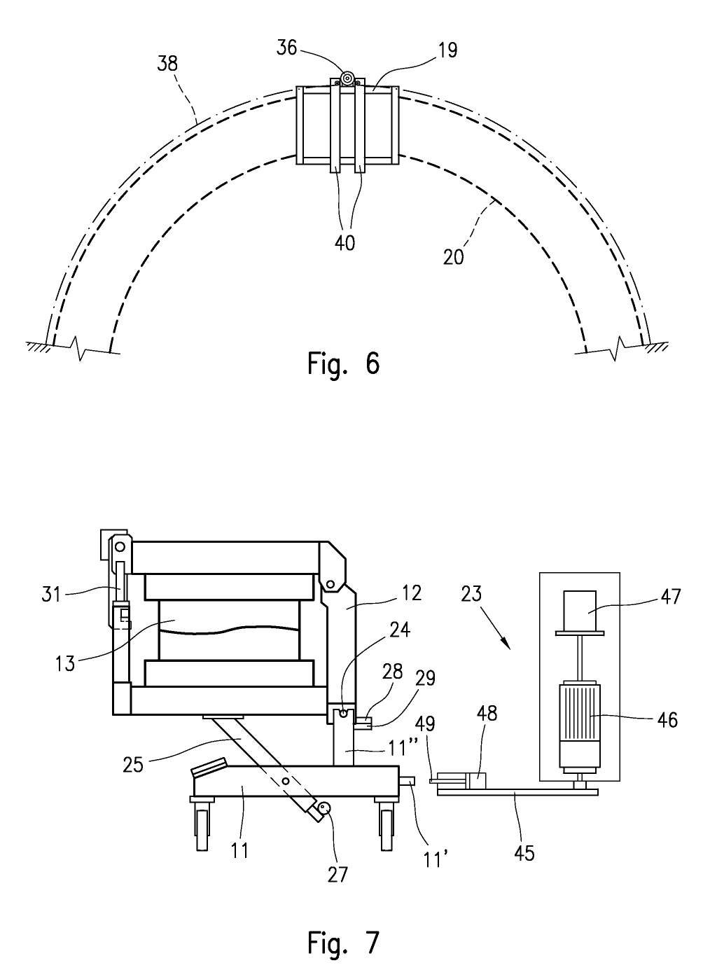

In the case shown, the shuttle 19 comprises a base frame 34 provided with caster wheels 35 which guide the shuttle along the rails 20. The shuttle 19 is moved by an electric motor 36 connected to a gear wheel 37 which engages with a positive drive belt 38 secured at its two ends, which extends along the subsidiary path defined by the guide rails 20, as shown in FIGS. 4, 5 and 6.

The control for the position and speed of the shuttle 19 along its subsidiary path, is made possible by reference signals emitted by a signal generator or encoder 39 mechanically connected to the driving motor 36, as explained further on.

The shuttle 19 is also provided with means for gripping and translating the individual presses 12; in particular, from FIGS. 4 and 5 it can be seen that the shuttle 19 is provided with two telescopic forks 40, each comprising a stationary portion 40.1 and a longitudinally sliding upper portion 40.2, which can protrude from one or both sides of the shuttle 19; an electric motor 41 with a suitable signal generator 41′, by means of a suitable mechanical transmission 42 is operatively connected to the sliding parts 40.2 of both the forks 40 of the shuttle.

As shown in FIG. 5, both of the forks 40 are supported by a beam 43 which extends transversally to the structure 34 of the shuttle 19; the beam 43 in turn is supported by actuators 44 for example electric or other types of actuators, to raise and lower the forks 40 in a controlled manner.

As mentioned previously, the position and speed of the shuttle 19 during the gripping and transferring steps of a press 12, must be appropriately controlled and co-related to the position and speed of a specific carriage 11 which moves along the curved section 14′, or in the section in which the removal and replacement of the mold holder presses must take place.

In this connection, reference number 23 in FIG. 1 has been used to indicate a device for providing a reference signal indicative of the position and the speed of the specific carriage 11 as it moves along the curved section 14′ of the carriage path, in which the removal and/or replacement of the presses together with the relevant mold must take place.

An embodiment of the device 23 is shown in FIG. 7 where the same numerical reference numbers of FIG. 1 have been used to indicate similar or equivalent parts.

In particular, from FIG. 7 it can be seen that the device 23 comprises a rotating arm 45 which extends horizontally towards the section 14′ of the rails for the carriages 11; the arm 45 is connected to the shaft of an electric motor 46 in turn operatively connected to a signal generator or encoder 47. The rotating arm 45 at its front end is provided with a device for coupling to the carriage 11, represented by a pneumatic cylinder 48 having a locking pin 49 at the front end of the piston rod, conformed in such a way as to engage with and disengage from a plate or coupling member 11′ on the rear side of each carriage 11.

The arm 45 in FIG. 1 is in a disengagement position of the carriages, oriented towards a starting point of the shuttle 19. By operating the cylinder 48, while maintaining the electric motor 46 switched off, the arm 45 latches on to a carriage 11 in transit, which drives it into rotation, while the carriage 11 itself moves along the path 14′; during the rotation of the arm 45 the signal generator 47 sends to the control unit of the shuttle 19 a reference signal co-related to the instantaneous position and speed of the carriage 11.

Once the removal and/or replacement steps of a press have been completed, by operating the cylinder 48 once more, the arm 45 is disengaged from the carriage 11 which continues its movement, while the arm 45 is made to rotate in the opposite direction by the motor 46 which returns it to its initial position. FIG. 7 shows a preferential embodiment of the device for controlling the position and speed of the carriages; however, it is evident that other solutions capable of achieving the same result, which fall within the sphere of the present invention, are possible.

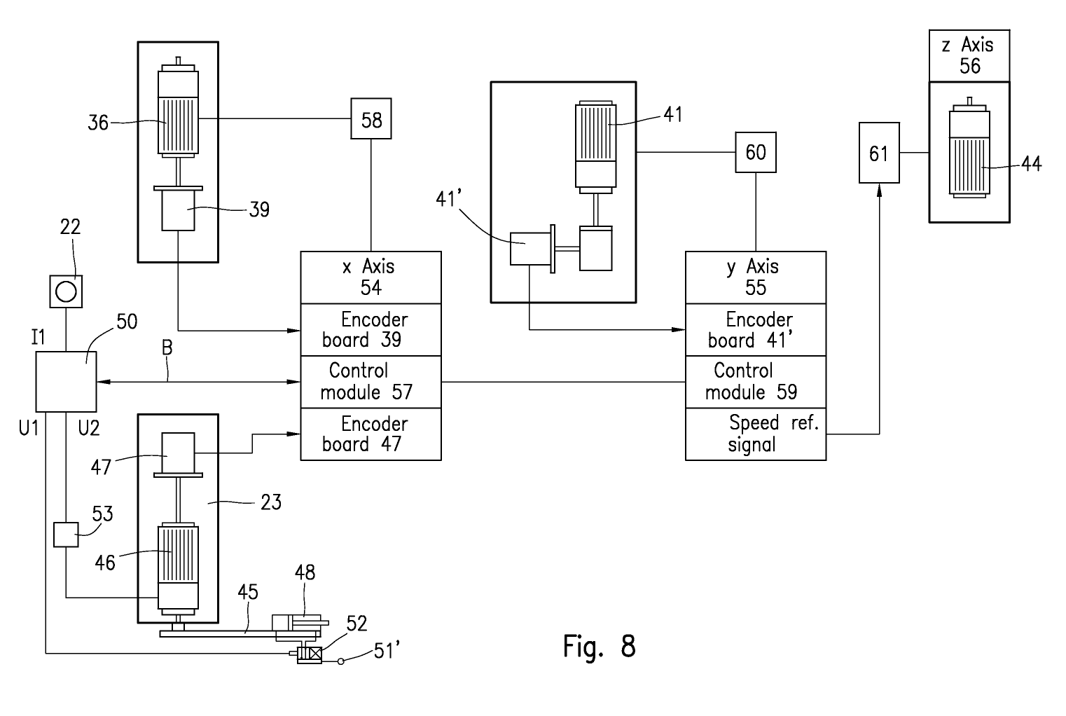

FIG. 8 represents a block diagram of the apparatus which controls the procedure for the tracking of the carriages 11 by the shuttle 19 and the steps of transferring the presses; in FIG. 8 the same reference numbers as in the previous figures have been used to indicate similar or equivalent parts.

As shown, the apparatus comprises a central control unit 50 of programmable type, for the management of the entire manufacturing process, one inlet I1 of which receives from the sensor 22 a detecting signal of the arrival of a carriage 11 and the identification code.

A first outlet U1 of the control unit 50 controls a valve assembly 52 for the connection to a pressurized air source 52′, of the pneumatic cylinder 48 which controls the locking pin 49 for coupling to the carriages 11, of the device 23 for detecting the position and the speed of a specific carriage during the press changing procedure.

A second outlet U2 of the unit 50 controls the driver or power circuit 53 for the motor 46 which controls the return to the starting position of the rotating arm 45, after it has been disengaged from a carriage 11.

The system of FIG. 8 also comprises, an onboard unit 54 of the shuttle 19, which controls an axis “X” of the system, that is to say, the position of the shuttle 19 along the respective path; an onboard unit 55 for controlling an axis “Y”, that is to say, of the motor 41 which controls the movements of the forks 40 in a direction transversal to the axis “X′”; and an onboard unit 56 for controlling an axis “Z” at right angles to the previous ones, that is to say, the motor 44 which controls the vertical raising and lowering movements of the forks 40.

More precisely, according to the block diagram of FIG. 8, the control unit 54 for the axis X comprises a first control module 57 or PLC onboard the shuttle 19, operatively connected to the central control unit 50 of the entire system by a field bus B. The control module 57 of the onboard PLC is also operatively connected to the control cards of the encoder or signal generators 39 and 47, as well as to the driver 58 or power circuit for the motor 28 of the shuttle 19.

In turn, the unit onboard the shuttle comprises a second module 59 for controlling the axis Y operatively connected to the control module 57, to the encoder card of the signal generator 41′, and to the driver 60 supplying power to the motor 41 for the sliding movement of the forks 40.

Lastly, the control module 59 the axis Y, by a speed reference signal, controls the driver 61 supplying power to the motor 44 of the unit 56 relating to the axis Z for the vertical movements of the forks 40.

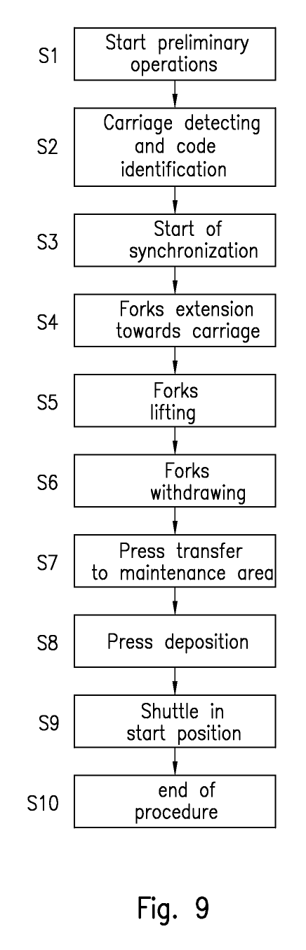

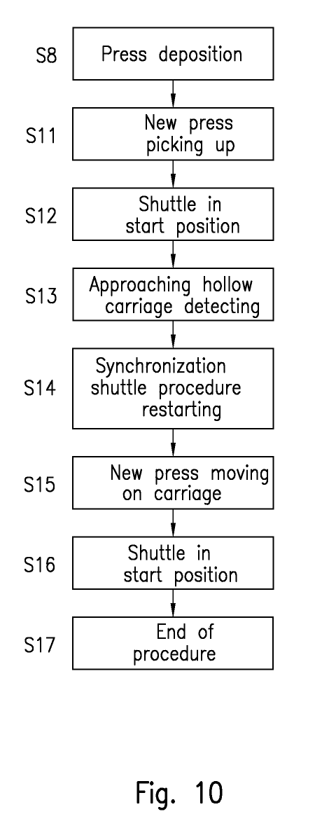

With reference to the flow diagrams of FIGS. 9 and 10, and to the following figures, a description will now be given of the press changing procedures, in conformity with the method according to the invention, in several of its possible alternatives.

With reference to the flow diagram of FIG. 9, first of all a description will be given of the procedure for changing a press along the curved section 14′ of the carriage path of FIG. 1.

After having started up the preliminary operations, step S1, the central control unit 50 waits for a signal from the sensor 22, indicative of the presence of a carriage 11 in arrival, and recognition of the identification code.

Upon recognition of the identification code, step S2, if the working program stored in the central control unit 50 does not contemplate the changing of the press, the shuttle 19 remains stationary in its starting position and the coupling device 23 remains disengaged, while the carriage 11 continues its movement towards the work stations 15, along the processing line 14.

Conversely, if the press 12 identified by the recognition code has to be removed from the respective carriage 11 according to the stored working program, or for other causes, the control unit 50 starts up the step S3 for synchronizing the movement of the shuttle 19 with the movement of the identified carriage 11.

During this step, the rotating arm 45 of the device 23 for detecting the position and the speed of the carriages, by the pin 49 actuated by the cylinder 48 engages the plate 11′ of the carriage 11, which consequently drives it into rotation, in that the motor 46 is switched off. The rotating arm 45 in turn drives into rotation the signal generator 47 which supplies the control module 57 of the shuttle 19 with a position reference signal during the tracking procedure of the carriage.

Simultaneously, the signal generator 39 supplies the module 57 with a reference signal of the speed and position of the shuttle 19.

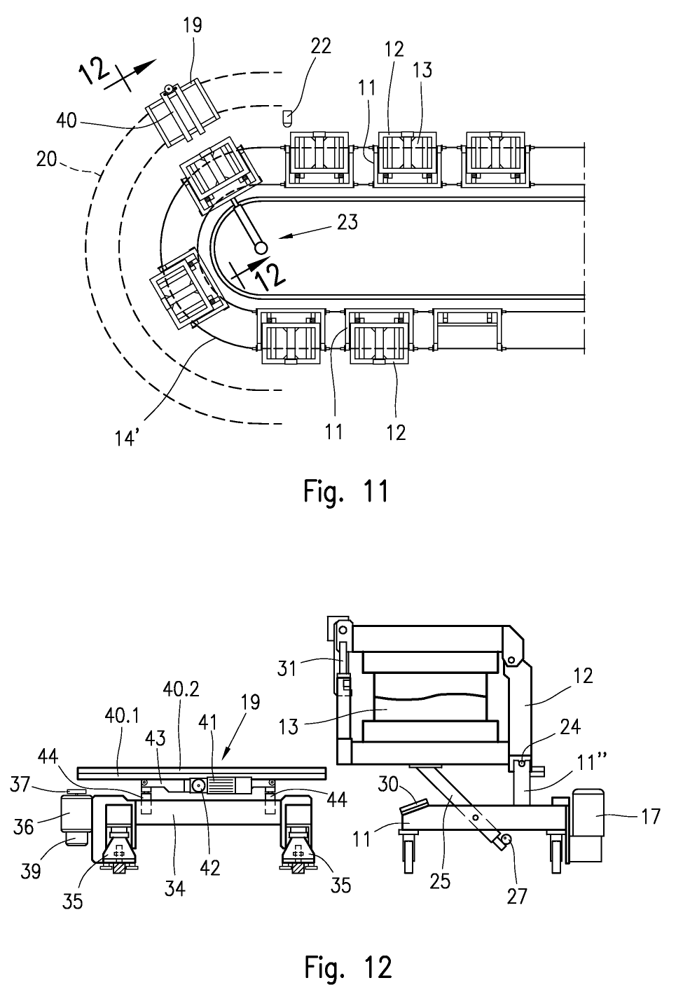

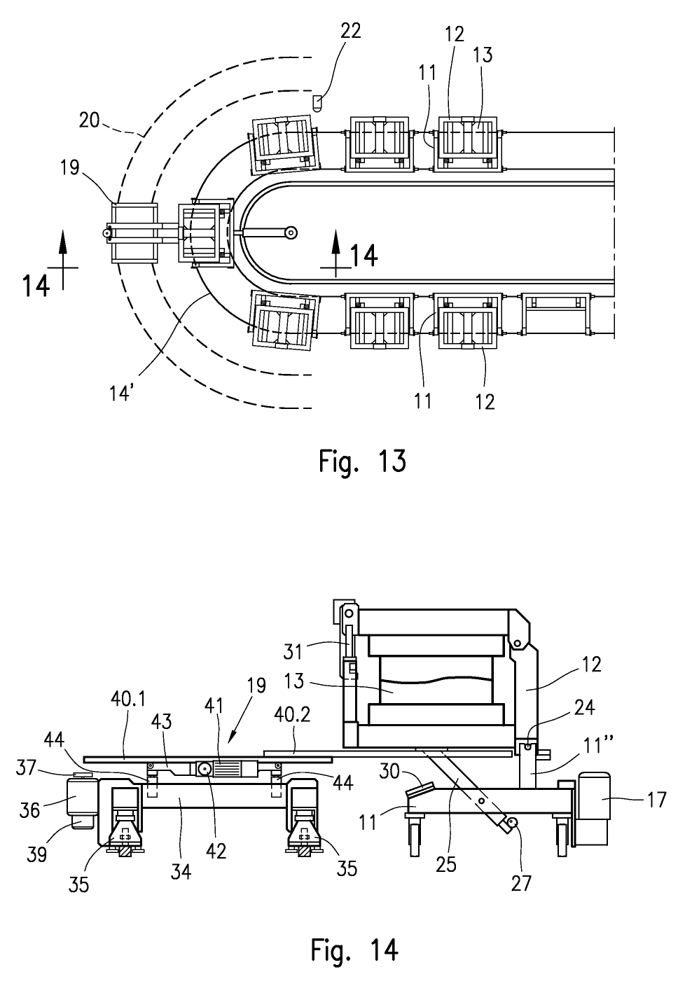

As soon as the shuttle 19 is perfectly aligned with the carriage 11, and maintains its relative position in a manner controlled by the onboard PLC as shown in FIGS. 11 and 12, the shuttle 19 extends the forks 40, step S4, positioning them underneath the press 12 with the carriage in movement, as shown in FIGS. 13 and 14.

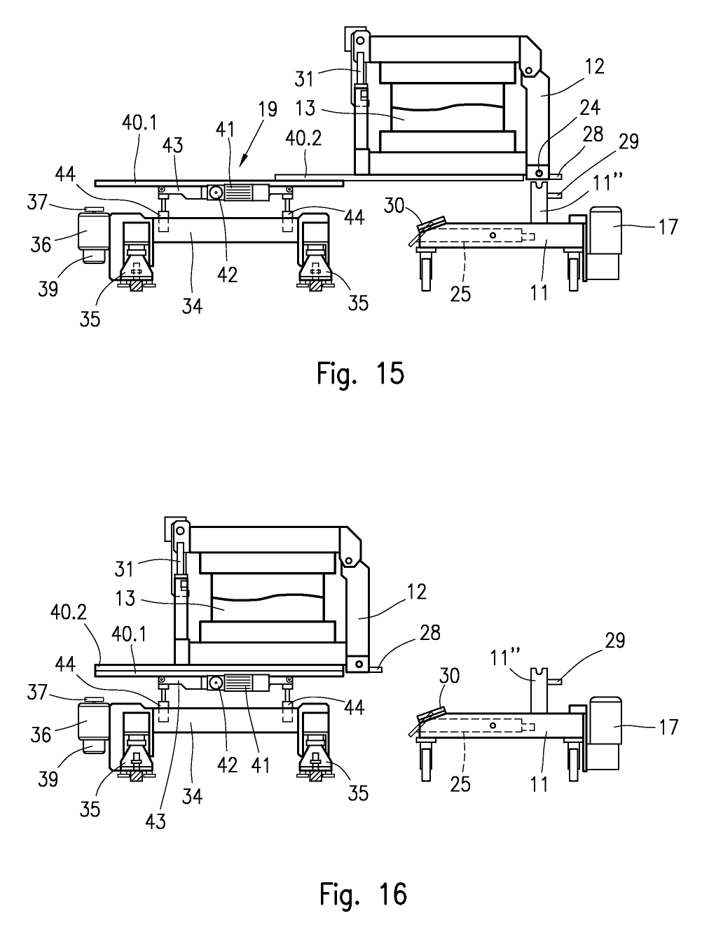

The subsequent step S5 consists in the upward movement of the forks 40 and the consequent lifting of the press, with the carriage 11 and the shuttle 19 in movement, FIG. 15, which is followed by step S6 consisting in the backward movement of the forks 40 together with the press 12, above the shuttle 19, FIG. 16.

The control algorithm for the position of the shuttle, stored in the onboard PLC, remains active until the end of the unloading and/or loading procedure of the press, in relation to the programmed working cycle.

In fact, after the forks 40 together with the press 12 have been moved backwards to the position of FIG. 16, the tracking procedure is interrupted, disengaging the rotating arm 45 from the empty carriage 11, while the latter continues its movement along the path 14.

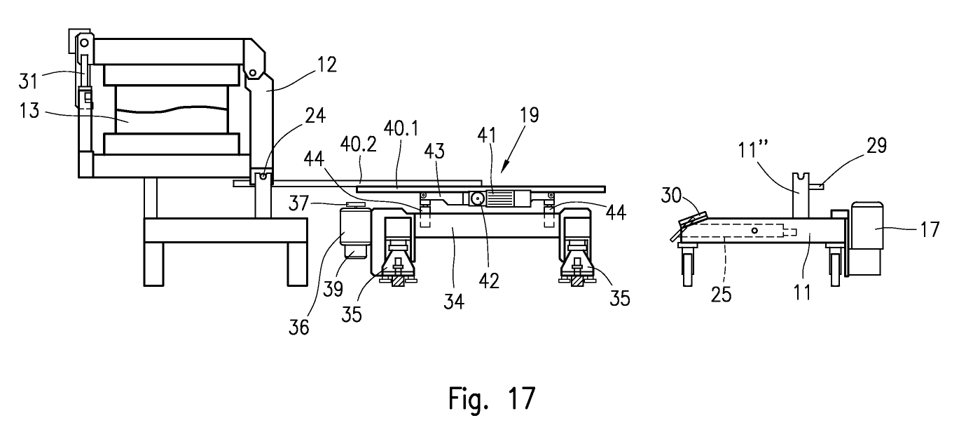

The motor 46 is now supplied with power to cause the arm 45 to rotate backwards, returning it to its initial position of FIG. 1, while the shuttle 19 can be stopped in the maintenance area 21, step S7; the forks 40 are now extended in the opposite direction to the first one, and lowered to rest the press 12 onto a work surface, step S8, as shown in FIG. 17. Once the press 12 has been lowered, the forks 40 are once again made to shift backwards and the shuttle 19 is made to return to its starting position, step S9, to wait for the removal of a subsequent press; at this point, the removal procedure of a press can be considered as having been concluded, step S10.

Conversely, whenever it is necessary to load a new press onto an empty carriage, with reference to the flow diagram in FIG. 10, upon completion of the step S8 for moving a press in the maintenance area 21, the shuttle 19 can be controlled to pick up a new press 12 on which the necessary maintenance operations and/or replacement of the mold have previously been carried out, step S11; consequently, the shuttle 19 with the new press is brought into the starting position, step S12, while waiting to detect the approaching of an empty carriage, step S13, upon the arrival of which the previous procedure for the synchronization of the movement of the shuttle 19 to that of the empty carriage is repeated, step S14, performing the reverse sequence of the forks 40 for loading the new press onto the carriage 11, step S15; after the forks 40 have been moved back, the shuttle 19 is made to return to the starting position, step S16, thereby bringing the procedure to end, step S17.

In the case just taken into consideration, use has been made of a shuttle with a single pair of forks 40, with the press change which takes place along the curved section 14′ of the path of the individual carriages 11, with the latter in movement and without any interruption of the working cycle.

Within the sphere of this invention, however, other variations tending to further improve the operative capacity of the entire plant are possible. For example, in substitution of the single shuttle provided with a single pair of forks, it is possible to contemplate the use of a shuttle provided with a double pair of forks, one of which can be used to remove a press from a carriage in the way previously described, and the other one for subsequently loading onto the same carriage a new press previously picked up from the maintenance area 21.

Although it is preferable to carry out the replacement of the presses in the curved section 14′ of the working path, for the reasons mentioned previously, the removal and/or replacement steps of the presses can also be carried out along a rectilinear section of the path 14.

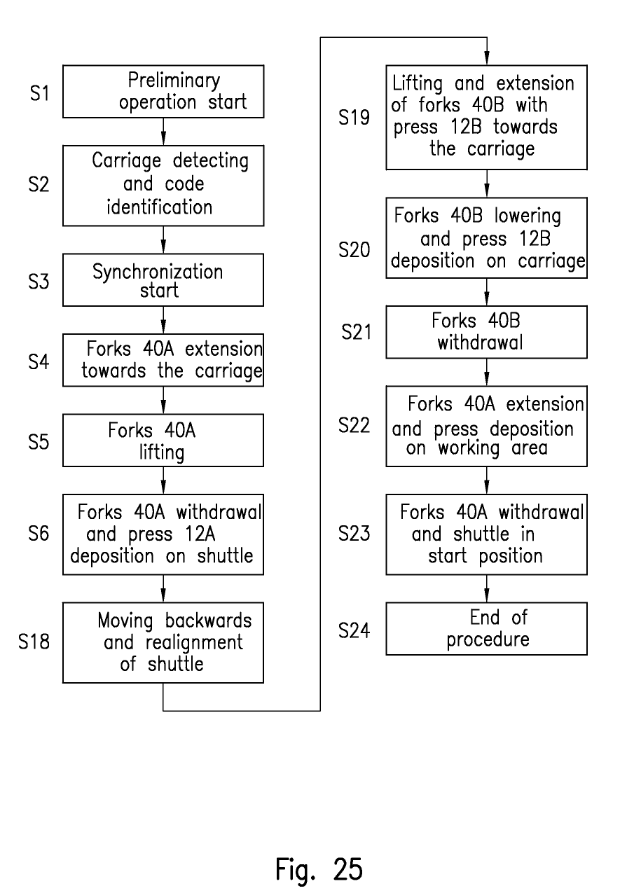

By way of example, the solution mentioned above is schematically indicated in the figures from 18 to 24, where the same reference numbers as the previous figures have been used to indicate similar or equivalent parts, as well as by the flow diagram of FIG. 25.

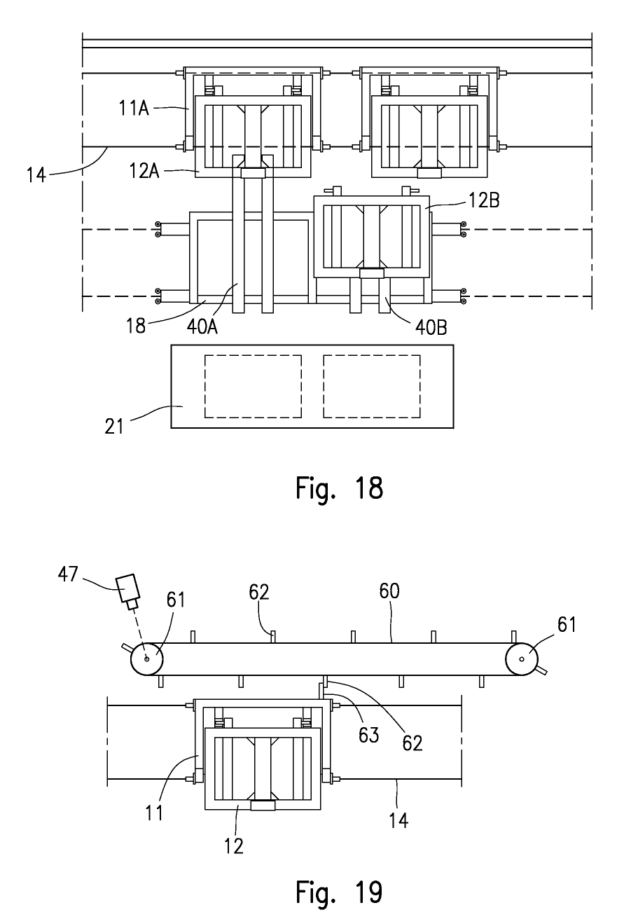

In particular in FIG. 18 the use is shown of a shuttle 19 provided with two pairs of forks 40A and 40B, which can be operated separately by a single control system, or by separate control systems, of the previously described type.

In the case of FIG. 18, the pair of forks 40A is aligned with the press 12A to be removed, while the new press 12B is already prepared on the pair of forks 40B in the forward position with respect to the press 12A.

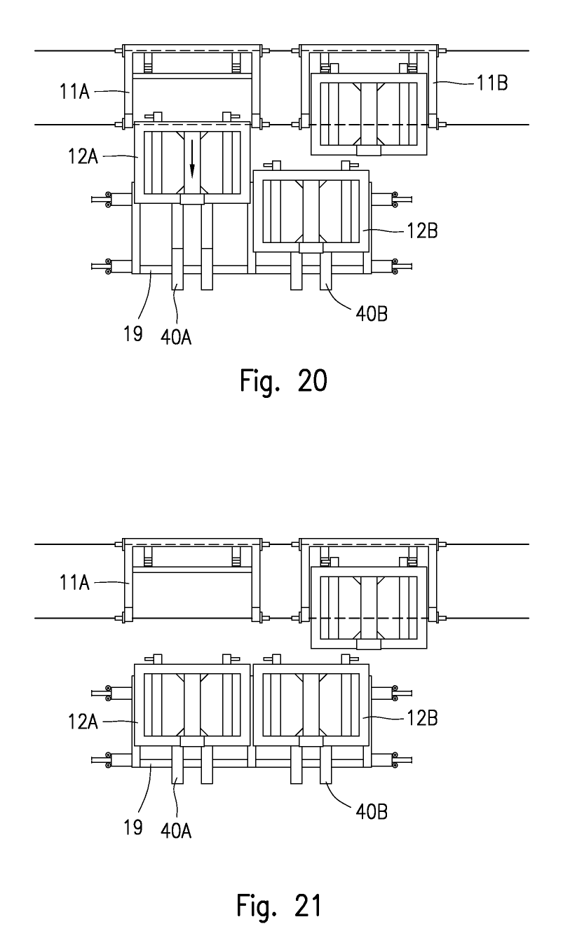

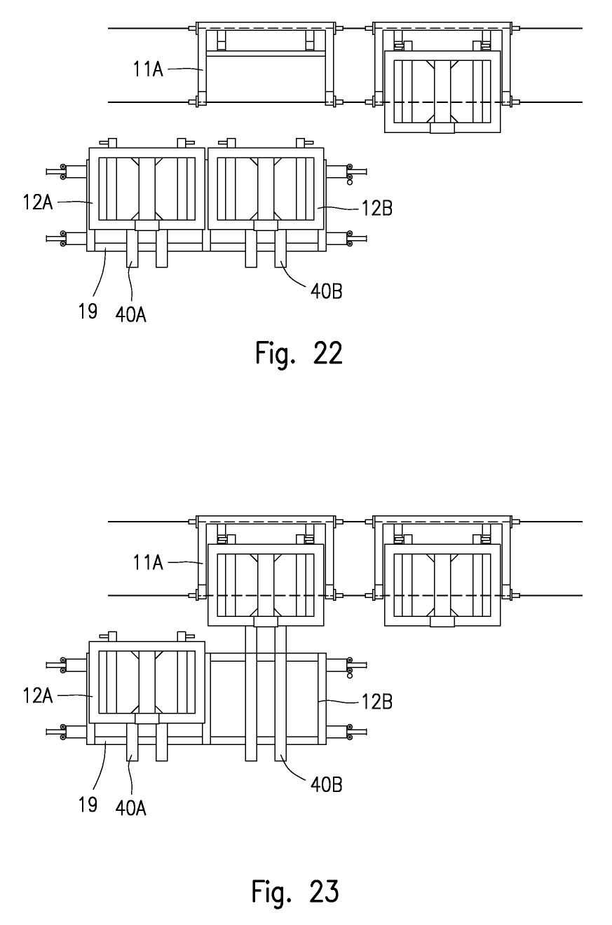

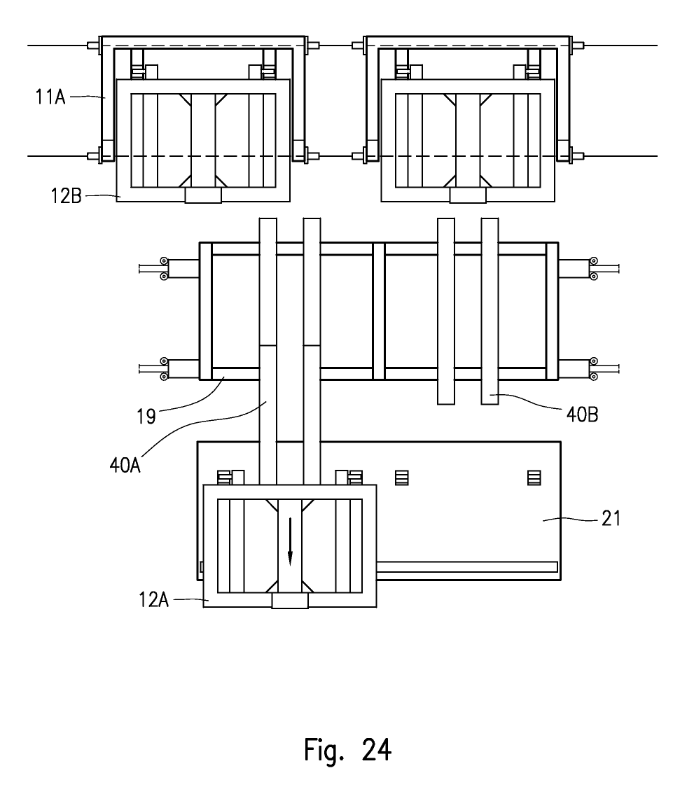

In the case of FIG. 18 in which the shuttle 19 with double forks 40A and 40B is used along a rectilinear section of the path 14 of the carriages 11, in substitution of the rotating arm 45 and of the signal generator 47 of FIG. 7 it is possible to use a linear coupling system for the carriages 11 and for controlling the signal generator 47 shown in FIG. 19; in the case shown, the system for coupling the signal generator 47 to a carriage 11 in transit along the removal and/or replacement area for the presses, or maintenance area, comprises a chain 60, a toothed belt or the like, which extends to form a ring between two idle rotating gear wheels 61, one of which is mechanically connected to the signal generator 47. The chain or toothed belt 60 is provided with a plurality of protruding pegs 62, spaced apart from one another by a constant pitch, to be engaged by an entrainment pin 63 on each carriage 11; in this way, the chain 60 and the signal generator 47 are driven into rotation by each carriage 11 during its transit in the removal and/or replacement area for the presses.

The figures from 20 to 24 show a top view of the section of the line along which the removal and/or replacement procedure for the presses takes place, according to the method and by means of the system in conformity with this invention, while the flow diagram of FIG. 25 illustrates its procedure.

In particular, FIG. 20 shows the alignment of the forks 40A with the press 12A positioned on the carriage 11A, while the forks 40B support a new press 12B which will be loaded onto the carriage 11A once the press 12A has been removed; as can be seen in FIG. 20, during the removal of the press 12A, the shuttle 19 moves with the forks 4A aligned with the carriage 11A while it is running along the processing line.

FIG. 21 shows the completed transfer of the press 12A on the shuttle 19 according to the previously described procedure, while FIG. 22 shows a subsequent step in which the shuttle 19 has been made to shift backwards with respect to the carriage 11A, bringing the forks 40B together with the new press 12B in line with the carriage; the procedure continues with the loading of the new press 12B onto the empty carriage 11A. In this case the control algorithm again maintains synchronism conditions of movement of the shuttle 19 with respect to the carriage 11A; indeed, in the case described, once the press 12A has been removed, the control system must be such as to cause the shuttle 19 to shift backwards by a pitch in order to align the forks 40B together with the new press 12B, with the empty carriage 11A as shown in FIG. 22 and then carry out the loading procedure the press 12B onto the empty carriage 11A in the way previously described, as shown in FIG. 23.

FIG. 24 in turn shows the step for transferring the press 12A onto an appropriate working surface in the maintenance area 21, after the shuttle has been once again disengaged from the carriage.

FIG. 25 shows the flow diagram and the method for changing a press, by means of the shuttle with double forks 40A and 40B of the previous figures.

The steps from S1 to S6 take place in the way previously described in FIG. 9; upon completion of the step S6 for shifting the forks 40A backwards and for the deposition of the press 12A on the shuttle 19, there then follow the steps from S18 to S24 according to which the shuttle 19 is made to move back by a pitch in order to realign the forks 40B of the press 12B with the empty carriage 11A, step S18; then the forks 40B are raised and moved together with the press 12B towards the empty carriage 11A, step S19. Subsequently, the forks 40B are lowered, depositing the press 12B onto the carriage 11A in movement, step S20; the forks 40B are then made to move backwards again, step S21 then, after the disengagement of the shuttle 19 from carriage 11A, the forks 11A are extended on the opposite side, depositing the press 12A on the working surface 21, step S22. Lastly, the forks 40A are made to move backwards and the shuttle 19 is returned to the starting position, step S23, ending the procedure with the step S24.

It is understood that what has been described and shown with reference to the accompanying drawings, has been given purely in order to illustrate the general characteristics of the method and the system for changing presses in movement according to the invention, as well as several preferential embodiments. Therefore, other variations or modifications may be made to the procedure of removing and loading the presses, to the carriages and to the presses themselves or parts thereof, without thereby deviating from the claims.

1. A method for automatically changing mold holder presses in a processing plant for the continuous manufacture of molded articles of plastic material, according to which each mold is enclosed in a clamping press removably supported by a respective carriage movable along a path of a processing line, comprising the steps of:
providing each press and/or carriage with an identification code;
providing a shuttle with press gripping members for gripping and transferring the presses, said shuttle being movable along a subsidiary path which develops parallel to the working path of the carriages along the processing line, in correspondence with a press and mold removal and/or replacement area;
detecting the approaching of a carriage in the press removal and/or replacement area;
identifying an approaching carriage with a press to be removed, and starting the shuttle to bring it alongside the detected carriage in movement;
generating first and second reference signals indicative of the position and/or speed of the detected carriage, and respectively of the shuttle in movement;
bringing the shuttle alongside the detected carriage;
synchronizing the speed of the shuttle with the speed of the detected carriage by said reference signals; and
removing the mold holder press from the carriage in movement, by lifting and transferring the press onto the shuttle as they move in synchronism along the removal area.

2. The method according to claim 1, comprising the step of stopping the shuttle and transferring the removed press, to a maintenance area.

3. The method according to claim 2, comprising the steps of:
positioning a new press on the shuttle;
detecting an empty carriage approaching said removal and replacement area;
starting the shuttle and bringing it alongside the empty carriage in movement;
generating first and second reference signals indicative of the speed and position of the empty carriage and respectively of the shuttle;
bringing the shuttle alongside the empty carriage, synchronizing their speed by said reference signals; and
transferring the new press from the shuttle to the empty carriage while they are moving in synchronism along said removal or transfer area.

4. The method according to claim 1 comprising the step of transferring a press between a carriage and the shuttle while moving in synchronism along a curved section of transfer area (14′).

5. The method according to claim 1, comprising the step of transferring a press between a carriage and the shuttle while moving in synchronism along a linear section of the transfer area (14′).

6. A method for automatically changing mold holder presses in a plant for the continuous manufacture of molded articles of plastic material, according to which each mold is clamped in a press removably supported by a respective carriage movable along a path of a processing line, comprising the steps of:
providing each press and/or carriage with an identification code;
providing a shuttle with press gripping members for gripping and transferring the presses, said shuttle being movable along a subsidiary path which develops parallel to the path of the carriages along the processing line, in correspondence with a press and mold removal and/or replacement area;
providing a first press with relevant mold onto the shuttle;
detecting the approaching in the press removal and/or replacement area, of a carriage with a second press to be removed;
identifying the approaching carriage and/or press, and starting the shuttle to bring it alongside the detected carriage in movement;
generating first and second reference signals indicative of the position and/or speed of the approaching carriage and respectively of the shuttle;
bringing the shuttle alongside the carriage;
synchronizing their speeds by said reference signals;
picking up said second press from the detected carriage, by lifting and transferring the press onto the shuttle as it moves in synchronism with the carriage;
bringing the shuttle with the first press, alongside and aligned with the now empty carriage, continuing to synchronize their speed by said reference signals; and
transferring the aforesaid first press from the shuttle to the empty carriage while they are moving in synchronism along said removal and/or replacement area.

7. The method according to claim 6, comprising the step of transferring a press between a carriage and the shuttle while are moving in synchronism along a curved section of the removal area (14′).

8. The method according to claim 6, comprising the step of transferring a press between a carriage and the shuttle while they are moving in synchronism along a linear section of the removal area.

9. A system for automatically changing mold holder presses, in which each mold holder press is removably supported by a respective clamping carriage movable along a working path of a processing line, and in which a press removal and/or maintenance area has been provided alongside said working path, comprising:
means for detecting and identifying each press and/or carriage approaching said removal and maintenance area;
a presses transferring shuttle movable along a subsidiary path which extends parallel to the working path, in correspondence with said press removal area, the shuttle being provided with press gripping means conformed to lift and move each press between a carriage and the shuttle;
a first signal generator in correspondence with said removal area, to generate a first reference signal co-related to the position and speed of an approaching carriage;
means for connecting the first signal generator to the approaching carriage in correspondence with said press removal area;
a second onboard signal generator for the transfer shuttle, for generating a second reference signal co-related to the position and speed of the same shuttle;
a central control unit for the processing line;
an onboard control unit for the shuttle operatively connected to said central unit and to said signal generators;
the onboard control unit of the shuttle comprising program means for controlling and co-relating, by said reference signals, the position and speed of the shuttle to the position and speed of the carriage in movement, respectively for controlling the lifting and the transfer of a press between a carriage and the shuttle side by side arranged in movement along said removal area.

10. The system according to claim 9, in which the shuttle comprises:
at least one pair of extensible forks for lifting and transferring the presses, said forks being horizontally slidable between a backward condition and a forward condition in which they protrude from at least one side of the shuttle;
support means for supporting the forks, vertically movable between a lowered and a raised position;
first control means operatively connected to the forks, to the support means and to the onboard control unit of the shuttle, conformed to control the horizontal and vertical movements of the forks and respectively of the aforesaid fork support means.

11. The system according to claim 10, in which said first control means comprise a third reference signal generator for the extension movements of the forks, operatively connected to a control actuator for the extension movements of the forks, respectively connected to the onboard control unit of the shuttle.

12. The system according to claim 9, comprising second control means conformed to move the shuttle in synchronism with the movement of a carriage, said second control means being operatively connected to said second signal generator.

13. The system according to claim 9, in which the carriages and the shuttle are movable along respective arch shaped paths, in correspondence with said press removal and/or replacement area; the first signal generator being operatively connected to a rotating arm, concentrically arranged to the carriages and shuttle paths, and coupling means on the rotating arm, to engage and disengage each carriage in movement along said removal and/or replacement area for the presses.

14. The system according to claim 13, in which the rotating arm is operatively connected to a driving motor, said driving motor being deactivated during the entraining movement of the rotating arm by a carriage.

15. The system according to claim 11, in which the carriages and the shuttle are movable along rectilinear paths in correspondence with said removal and/or replacement area; in which the first signal generator is operatively connected to a transmission engageable with each carriage in movement, which extends parallel to said removal and/or replacement area.

16. The system according to claim 9, in which the shuttle comprises a single pair of forks for lifting and translating the presses.

17. The system according to claim 9, in which the shuttle comprises first and second pair of forks for lifting and translating the presses, and separate control means for said first and second pair of forks, operatively connected to the onboard control unit of the shuttle.

18. The system according to claim 17, in which the onboard control unit of the shuttle is programmed to align one of the pairs of forks to a carriage, to raise and remove a press, and, respectively, is programmed to subsequently align the second pair of forks to the now empty carriage, for the transfer and deposition of another press already positioned on the shuttle forks.

19. The system according to claim 9, in which the onboard control unit of the shuttle comprises a first control module operatively connected to position reference signal generators of a carriage respectively of the shuttle, and a second control module operatively connected to the signal generator and to an actuator for the sliding movement of the forks, and to the actuator for the lifting and lowering movements of the forks.

20. The system according to claim 9 comprising means for coupling the shuttle to individual carriages along the removal and replacement area for the presses.
